(19) United States
(12) Patent Application Publication
(10) Pub. No.: US 2010/0080013 A1
(43) Pub. Date: Apr. 1, 2010

(54) FRONT ASSEMBLY UNIT FOR A MOTOR VEHICLE, AND CORRESPONDING MOTOR VEHICLE

(75) Inventors: Caroline Riviere, Valentigney (FR); Sebastien Berne, Luze (FR)

Correspondence Address: YOUNG & THOMPSON, 209 Madison Street, Suite 500, Alexandria, VA, 22314, US

(73) Assignee: FAURECIA BLOC AVANT, Nanterre (FR)

(21) Appl. No.: 11/995,020

(22) PCT Filed: Jun. 29, 2006
(86) PCT No.: PCT/FR06/01523

§ 371 Date: Jan. 8, 2008

(30) Foreign Application Priority Data
Jul. 8, 2005 (FR) 0507345

(51) Int. Cl. F21V 19/00

(52) U.S. Cl. 362/523

(57) ABSTRACT

The inventive assembly comprises a front face (4) fixable to the front structure (3) of a motor vehicle and a device (6) for fixing optical units (5) and comprising two supports (30) which are remote from each other, each of which is used for carrying the optical unit (5) and is fixable to the front face by one side thereof and to a mud guard (8) of the vehicle body by the other side thereof, wherein the elasticity of each support (30) is substantially greater than the elasticity of the front face (4), thereby making it possible to absorb relative adjustment movements of the corresponding mud guard (8), front face (4) and/or of the optical unit (5). In another variant, the fixing device (6) comprises at least one connection element (52) which is used for connecting the supports (30) to each other and is embodied in one piece therewith.

The present invention concerns a front assembly unit for a motor vehicle, of the type comprising:
a front face intended to be fixed to the front of a motor vehicle structure; and
a fixing device for fixing lamp units, comprising two supports remote from each other and each intended to support a lamp unit, each support being fixed on the one hand to the front face and intended to be fixed on the other hand to a bodywork wing of the motor vehicle, the resilience of each support being substantially greater than that of the front face in order to absorb relative adjustment movements of the corresponding wing, of the front face and/or of the corresponding lamp unit.

The document PP 1 232 932 describes a front assembly unit of the aforesaid type, in which the supports are constituted by two distinct, separate beams, each intended to receive a lamp unit, each beam comprising an end rigidly fixed to the front face and extending so as to protrude laterally from the front face.

The absorption of the relative adjustment movements makes it possible to prevent a defect of continuity of surface of the visible part of the lamp unit and of the corresponding wing from substantially spoiling the aesthetic quality of the vehicle.

Nevertheless, the addition of support beams for lamp units increases the complexity of assembly of the front assembly unit, and also its manufacturing cost.

It is an aim off the present invention to provide a front assembly unit of the aforesaid type which is simple to manufacture and of low cost.

To this end, the invention proposes a motor vehicle front assembly unit of the aforesaid type, characterized in that the fixing device comprises at least one connecting member connecting the supports and made in one piece with the supports.

According to other embodiments, the front assembly unit comprises one or more of the following characteristics, taken singly or in all the technically possible combinations:
each support comprises a first part fixed to the front face and a second part intended to support the lamp unit and to be connected to a wing, the first and second parts being connected to one another by a zone made in one piece with the first and second parts, and having a flexibility greater than that of the first and second parts about an axis;
the or each connecting member connects the second parts of the supports to one another;
the fixing device comprises a cross-member extending transversely between the supports and forming a connecting member;
the cross-member is connected at each of its ends to a support via a web;
each web extends substantially parallel to a longitudinal median plane of the motor vehicle when the front assembly unit is mounted on the motor vehicle; and
it comprises at least one of the following elements:
two lamp units, each supported by a respective support;
a bumper reinforcement intended to be covered by a bumper skin; and
a bumper skin.

The invention also concerns a motor vehicle comprising a front assembly unit as defined above.

The invention and its advantages will become clearer from the following description, provided solely by way of example, and with reference to the appended drawings, in which:

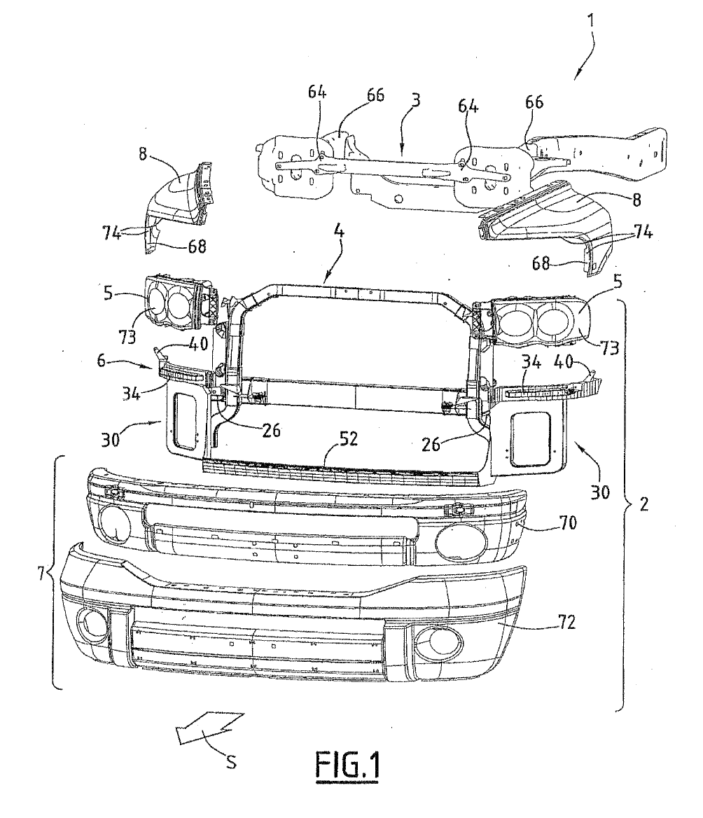

FIG. 1 is an exploded perspective view of a front assembly unit according to the invention, intended to be fixed to the front of a structure of a motor vehicle;

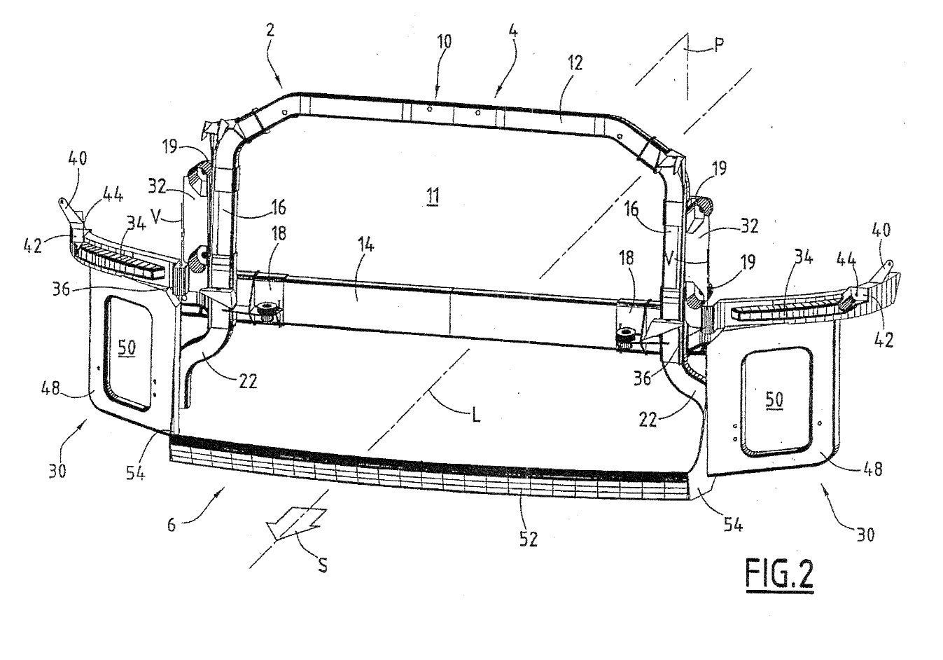

FIG. 2 is a view analogous to that of FIG. 1, illustrating only a front face and a fixing device for fixing lamp units of the front assembly unit of FIG. 1;

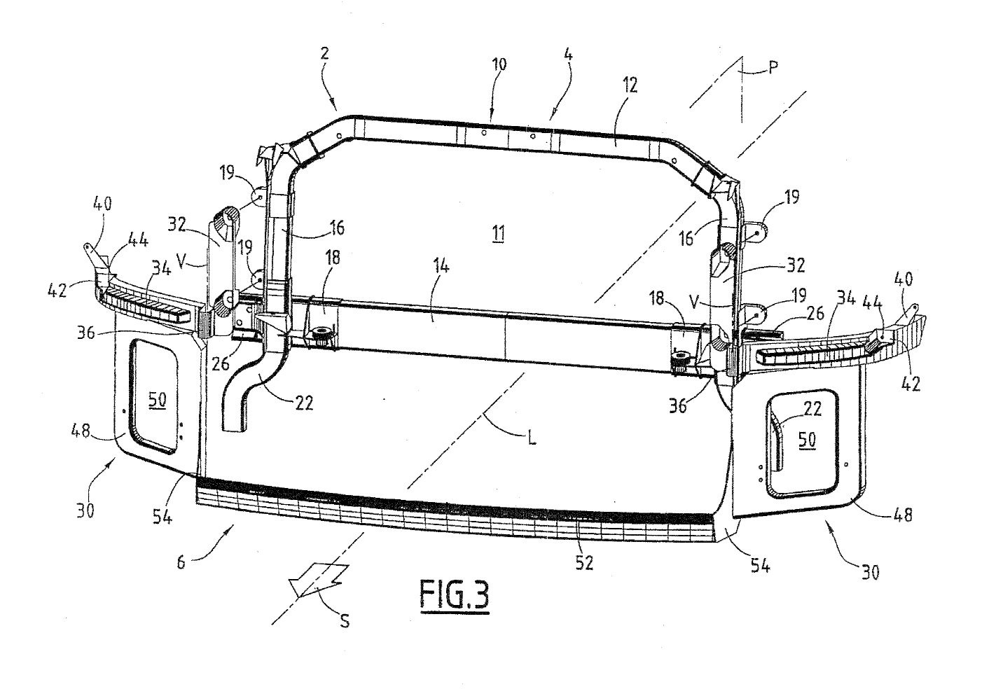

FIG. 3 is an exploded view analogous to that of FIG. 2; and

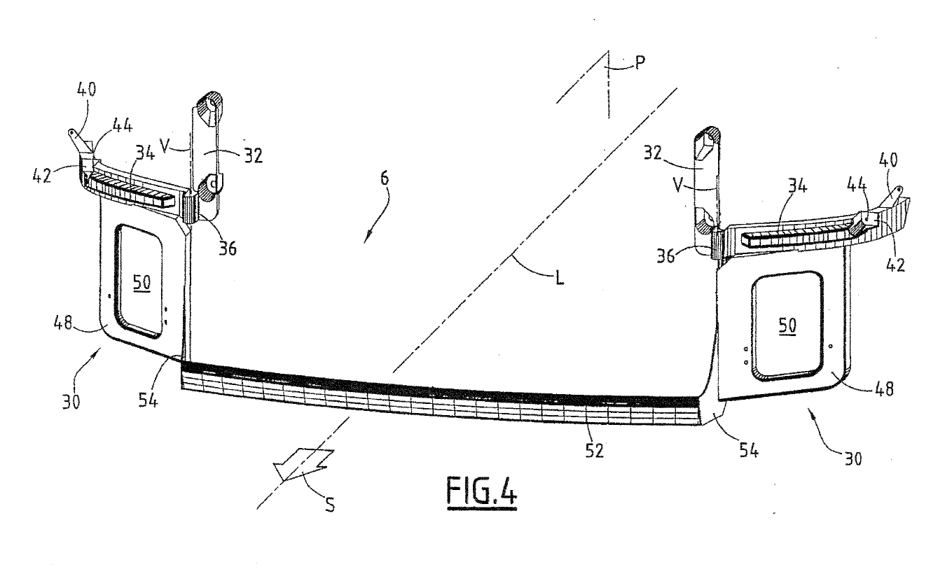

FIG. 4 is a view analogous to FIG. 3, illustrating the fixing device alone.

As illustrated in FIG. 1, the front assembly unit 2 comprises a front face 4 intended to be fixed to the front of a structure 3 of a motor vehicle 1, of which only a front part is shown, lamp units 5, for example two in number, a device 6 for fixing the lamp units 5 on the front face 4, and a bumper 7.

The vehicle comprises bodywork wings 8, fixed in a manner known per se on the structure 3. The wings 8 are cut out to follow the upper edges and the outer lateral edges of the lamp units 5.

Each lamp unit 5, in a manner known per se, comprises a substantially sealed housing comprising a transparent glass, and containing one or more lamps, such as low beam lamps, head lamps, fog lamps and/or indicator lamps.

In the continuation of the description, the orientations used are the customary orientations for motor vehicles.

Thus, the terms “front”, “rear”, “longitudinal”, “transverse”, “lateral”, “lower”, “upper”, “up” and “down” extend relative to the direction and to the direction of movement of the motor vehicle in forward motion, illustrated by an arrow S in FIG. 1.

As illustrated in FIGS. 2 and 3, the front face 4 is substantially rigid and comprises a frame 10 extending transversely to the longitudinal direction L of the vehicle.

The frame 10 defines a central opening 11, and includes an upper cross-member 12 and a lower cross-member 14, horizontal and transverse, connected to each other by two vertical lateral stanchions 16.

The stanchions 16 and the cross-member 12 are for example made in one piece and obtained by bending a metal tube into an inverted U-shape. The cross-member 14 is for example a metal tube.

The cross-member 14 is rigidly fixed to the stanchions 16 via clips 18 made of plastics material, and obtained for example by overmoulding plastics material onto the stanchions 16 and the cross-member 14, which have been previously arranged in a mould. The clips 18 surround the stanchions 16 and the cross-member 14.

The front face 4 is termed “hybrid”, owing to the combined use of metal and plastics material.

The front face 4 comprises two pairs of fixing lugs 19 (FIG. 3) for fixing the device 6 on the front face 4. Each pair is arranged on a respective stanchion 16, the lugs 19 (FIG. 3) extending so as to protrude from the corresponding stanchion 16 laterally towards the outside of the front face 4. The lugs 19 (FIG. 3) are for example made in one piece with the clips 18.

Each stanchion 16 has a lower end portion 22 extending the stanchion 16 downwards from the cross-member 14.

The cross-member 14 comprises lateral end portions 26 (FIG. 3) laterally extending the cross-member 14 towards the outside from the stanchions 16.

As illustrated in FIGS. 2 to 4, the device 6 comprises two supports 30 spaced laterally from each other, and arranged laterally on each side of the front face 4 (FIGS. 2 and 3). Each support 30 is intended to support a lamp unit 5 (FIG. 1).

Each support 30 comprises a vertical stanchion 32, and an elongate beam 34 extending horizontally and laterally towards the outside from a lower end of the stanchion 32, and intended to support a lamp unit 5.

Each beam 34 is made in one piece with the corresponding stanchion 32 and is connected to the stanchion 32 by a zone 36 flexible about a vertical axis V and made in one piece with the stanchion 32 and the beam 34. The zone 36 has a flexibility about the axis V substantially greater than those of the stanchion 32 and of the beam 34 which it connects.

Each zone 36 is in the form of a film of material of little thickness transversely to the axis V, being able to deform without breaking so as to permit pivoting of each beam 34 relative to the corresponding stanchion 32.

Each beam 34 comprises an end opposed to the stanchion 32 and curved towards the rear, having a fixing lug 40 for fixing the beam 34 to a wing 8 (FIG. 1).

For the fixing of the corresponding lamp unit 5, each beam 34 has a recess 42 intended to receive a fixing lug for fixing the lamp unit 5, the recess 42 having a bottom provided with a hole 44 for the passage of a fixing device, for example a screw.

Each support 30 comprises a plate 48 made in one piece with the beam 34 and extending the beam 34 vertically downwards. Each plate 48 moves together with the corresponding beam 34 relative to the corresponding stanchion 32.

Each plate 48 is provided with an aperture 50 for receiving a functional member of the motor vehicle, for example a fog lamp.

The device 6 comprises a cross-member 52 connecting the supports 30, and made in one piece with these latter. The cross-member 52 is elongate and extends horizontally and transversely between the supports 30. The cross member 52 is connected at each of its ends to a plate 48 by a web 54. Each web 54 extends vertically and substantially parallel to a longitudinal plane P of the motor vehicle.

The cross-member 52 is offset towards the front relative to the supports 30, and is located on a level with the lower end of the plates 48.

As illustrated more precisely in FIG. 2, when the device 6 is fixed on the front face 4, the stanchions 32 are rigidly fixed to the front face 4. For this purpose, the stanchions 32 are arranged along the stanchions 16 and fixed onto the lugs 19 by means of fixing devices, for example bolts, screws and/or rivets.

The beams 34 extend so as to protrude laterally towards the outside from the front face 4.

The device 6 comprising a cross-member 52 connecting the supports 30 facilitates the manufacture of the device 6 and its mounting on the front face 4.

In fact, the device 6 can be manipulated in one piece, and a single operation is required for positioning the device 6 relative to the front face 4.

Moreover, the device 6 is a one-piece component and easily and inexpensively obtained in a single operation, for example by injection-moulding of plastics material.

As illustrated in FIG. 1, the assembly 2 is intended to be rigidly fixed to the structure 3 by fixing the portions 26 (FIG. 3) on the front ends 64 of side members 66 of the structure 3. The front face 4 thus completes the structure 3 to obtain a rigid structural assembly.

The lamp units 5 are fixed onto the beams 34.

The lugs 40 are rigidly fixed on flanges 68 of the wings 8, re-entrant towards the inside.

The bumper 7 comprises a bumper reinforcement 70 and a bumper skin 72 which are fixed to the device 6, more precisely, to the supports 30 and/or the cross-member 52, such that the skin 72 covers the reinforcement 70. The reinforcement 70 makes it possible to damp the impacts received by the skin 72.

Owing to the manufacturing tolerances, the positioning of the wings 8 relative to the front face 4 is imprecise, and surface discontinuities are likely to appear between the visible wail of the lamp units 5, which is constituted by a glass 73, and of the edges 74 of the wings 8 bordering the glass 73.

The resilience imparted to each support 30 by the material constituting the device 6 and by the zone 36, permits displacement of the beam 34 relative to the corresponding stanchion 32 which is fixed on the front face 4.

As a consequence, the relative adjustments between the wings 8, the front face 4 and the lamp units 5 are compensated by a slight displacement of the beams 34. The result is that the surface continuity between the glass 73 of each lamp unit 5 and the adjacent wing 8 is improved, without it being necessary to adjust the position of the lamp units 5 manually.

As a variant, each support 30 is devoid of a flexible zone between its stanchion 32 and its beam 34, and only the resilience of the material constituting the device 6 imparts sufficient resilience to the support 30, and especially to the beam 34, to compensate for the adjustments.

The webs 54 are thin enough to deform laterally in such a way that the cross-member 52 connecting the supports 30 does not hinder the displacement of the beams 34. Nevertheless, the vertical webs 54 offer sufficient resistance to vertical efforts. Consequently, it is possible to use the cross-member 52 as a support for the skin 72 and/or for the reinforcement 70.

The assembly 2 is prefabricated by incorporating the front face 4 and the device 6 and, optionally, the lamp units 5, the reinforcement 70 and/or the skin 72.

1. A front assembly unit for a motor vehicle, of the type comprising:
a front face (4) intended to be fixed to the front of a motor vehicle structure (3); and
a fixing device (6) for fixing lamp units (5) on to the front face (4), comprising two supports (30) remote from each other and each intended to support a lamp unit (5), each support (30) being fixed on the one hand to the front face (4) and intended to be fixed on the other hand to a bodywork wing (8) of the motor vehicle, the resilience of each support (30) being substantially greater than that of the front face (4) in order to absorb relative adjustment movements of the corresponding wing (8), of the front face (4) and/or of the corresponding lamp unit (5),
characterized in that the fixing device (6) comprises at least one connecting member (52) connecting the supports (30) and made in one piece with the supports (30).

2. An assembly according to claim 1, characterized in that each support (30) comprises a first part (32) fixed on the front face (4) and a second part (34, 48) intended to support the lamp unit (5) and to be connected to a wing, the first (32) and second (34, 48) parts being connected to one another by a zone (36) made in one piece with the first (32) and second (34, 48) parts, and having a flexibility greater than that of the first (32) and second (34) parts about an axis (V).

3. An assembly according to claim 2, characterized in that the or each connecting member (52) connects the second parts (34, 48) of the supports (30) to each other.

4. An assembly according to claim 1, characterized in that the fixing device (6) comprises a cross-member (52) extending transversely between the supports (30) and forming a connecting member.

5. An assembly according to claim 4, characterized in that the cross-member (52) is connected at each of its ends to a support (30) via a web (54).

6. An assembly according to claim 5, characterized in that each web (54) extends substantially parallel to a longitudinal median plane of the motor vehicle when the front assembly unit is mounted on the motor vehicle.

7. A front assembly unit according to claim 1, characterized in that it comprises at least one of the following elements:
two lamp units (5), each supported by a respective support (30);
a bumper reinforcement (70) intended to be covered by a bumper skin (72); and
a bumper skin (72).

8. A motor vehicle comprising an assembly (2) according to claim 1.

9. A front assembly unit according to claim 2, characterized in that it comprises at least one of the following elements:
two lamp units (5), each supported by a respective support (30);
a bumper reinforcement (70) intended to be covered by a bumper skin (72); and
a bumper skin (72).

10. A front assembly unit according to claim 3, characterized in that it comprises at least one of the following elements:
two lamp units (5), each supported by a respective support (30);
a bumper reinforcement (70) intended to be covered by a bumper skin (72); and
a bumper skin (72).

11. A motor vehicle comprising an assembly (2) according to claim 2.

12. A motor vehicle comprising an assembly (2) according to claim 3.

13. An assembly according to claim 2, characterized in that the fixing device (6) comprises a cross-member (52) extending transversely between the supports (30) and forming a connecting member.

14. An assembly according to claim 3, characterized in that the fixing device (6) comprises a cross-member (52) extending transversely between the supports (30) and forming a connecting member.
